(19) United States
(12) Patent Application Publication
(10) Pub. No.: US 2001/0036789 A1
(43) Pub. Date: Nov. 1, 2001

(54) Flat display screen plasma cleaning method

(76) Inventor: Denis Vion, Montpellier (FR)

Correspondence Address: ARTHUR L. PLEVY, ESQ., Duane, Morris & Heckscher LLP, Suite 100, 100 College Road West, Princeton, NJ, 08540, US

(21) Appl. No.: 09/793,016

(22) Filed: Feb. 26, 2001

(30) Foreign Application Priority Data
Feb. 25, 2000 (FR) 00/02407

(51) Int. Cl. H01J 9/38; H01J 9/39

(52) U.S. Cl. 445/6; 445/24; 445/40; 445/41

(57) ABSTRACT

A method for cleaning by plasma at least one electrode of a field effect flat display screen, consisting of causing the generation of a plasma in an internal space separating two parallel plates respectively forming the screen bottom and surface, and each supporting at least one electrode, before placing this internal space under vacuum and definitively closing it.

### BACKGROUND OF THE INVENTION

1. Field of the Invention

The present invention relates to a field effect (FET) flat display screen, for example with microtips. It more specifically applies to the manufacturing of such a screen, and more specifically to a plasma cleaning step to which is generally submitted at least one of the screen electrodes.

2. Discussion of the Related Art

Conventionally, a flat screen of the type to which the present invention relates is formed of two generally rectangular spaced apart external plates, for example made of glass. One plate forms the screen surface while the other one forms the screen bottom, for example provided with the emission means. The two plates are assembled by means of a peripheral seal, at a distance from each other to create an internal space isolated from the outside. The air in this internal space is generally pumped to create vacuum, or this space contains a neutral atmosphere (rare gas).

FIG. 1 shows an example of a conventional structure of a flat color microtip screen of the type to which the present invention relates.

Such a microtip screen is essentially formed of a cathode 1 with microtips 2 and of an extraction grid 3 provided with holes 4 corresponding to the locations of the microtips. Cathode 1 is placed opposite to a cathodoluminescent anode 5, a glass substrate 6 of which forms, for example, the screen surface.

The operating principle and a specific embodiment of a microtip screen are described, for example, in U.S. Pat. No. 4,940,916 of the Commissariat à l'Energie Atomique.

Cathode 1 is organized in columns and is formed, on a substrate 10, for example made of glass, of cathode conductors organized in meshes from a conductive layer. Microtips 2 are made on a resistive layer 11 deposited on the cathode conductors and are arranged within meshes defined by the cathode conductors. FIG. 1 partially shows the inside of a mesh, without showing the cathode conductors. Cathode 1 is associated with grid 3 which is organized in lines. Grid 3 is deposited on the cathode plate with an interposed isolating layer 12. The intersection of a line of grid 3 and of a column of cathode 1 defines a pixel.

This device uses the electric field created between cathode 1 and grid 3 to extract electrons from microtips 2. The electrons are then attracted by phosphor elements 7 of anode 5 if they are properly biased. In the case of a color screen such as illustrated in FIG. 1, anode 5 is, for example, provided with alternate strips of phosphor elements 7r, 7g, 7b, each corresponding to a color (Red, Green, Blue). The strips can be separated from one another by an insulator 8. Phosphor elements 7 are deposited on electrodes 9, for example formed of corresponding strips of a conductive layer (transparent if the anode forms the screen surface) such as indium and tin oxide (ITO). The sets of red, green, blue strips are for example alternately biased with respect to cathode 1, so that the electrons extracted from the microtips 2 of a pixel of the cathode/grid are alternately directed to the phosphor elements 7 facing each of the colors. In the case of a monochrome screen, anode 5 supports phosphor elements of the same color organized in a single plane or in two sets of alternate strips biased, in this case, separately.

Other cathode-grid and anode structures such as those described hereabove may be found. For example, the anode phosphor elements may be distributed in elementary patterns corresponding to the size of the screen pixels. The anode may further, while being formed of several sets of strips or of elementary patterns of phosphor elements, not be switched by sets of strips or patterns. All the strips or patterns then are at a same potential, for example, by being supported by a conductive plane. The anode is then said to be “unswitched” by opposition to “switched” anodes where the colors are alternately biased. On the cathode-grid side, several grids having respective functions of extraction and focusing may be provided.

Whatever the structure of the electrodes supported by substrates 10 and 6, the screen assembly technique is substantially the same. The cathode-grid and the anode are formed separately on the two substrates or plates 10 and 6, then still separately submitted to different degassing and cleaning processings before being assembled to each other by a peripheral seal. FIG. 2 schematically shows in cross-section the conventional structure of a microtip screen of the type to which the present invention relates. In FIG. 2, the cathode-grid assembly, supported by substrate 10, is designated by common reference 14. Similarly, anode 5, supported by substrate 6, is shown in a simplified manner.

The assembly of plates 6 and 10 is generally performed as follows. Spacers 16 intended for defining inter-electrode space 13 are first glued on cathode-grid 14. Spacers 16 are, for example, formed of regularly distributed glass balls so that the thickness of space 13 between plates 6 and 10 is substantially constant. Cathode-grid 14 is then submitted to a thermal processing under vacuum aiming at degassing the cathode and evaporating the glue of spacers 16. A similar processing is often applied, before assembly, to anode 5.

According to the assembly method to which the present invention relates, a pumping tube 17 is provided on the free surface of one of the plates (for example, plate 10). Tube 17 is, for example, made of glass and is sealed by an open end above a hole formed in plate 10 to establish a communication with space 13. According to this method, tube 17 is used to create vacuum in space 13 after assembly of plates 6 and 10. Tube 17 is generally placed in a corner of plate 10 outside of its useful surface area. Once the two plates 6 and 10 have been assembled by means of peripheral seal 15, the obtained structure is submitted, via tube 17, to a pumping at high temperature, which has the function of degassing space 13. Once vacuum has been created in the internal screen space, tube 17 is closed at its free end, generally after introducing therein a getter 18. The function of getter 18 is to absorb any contamination likely to appear during subsequent screen operation. In FIG. 2, tube 17 has been shown as closed, that is, once the screen has been finished.

Flat display screen structures to which the present invention relates, provided with tubes for pumping from the internal space, are described, for example, in French patent application no 2,761,196 of the applicant.

Before assembly of plates 6 and 10, said plates may be individually submitted to plasma cleaning steps. In particular, the beneficial effects of a hydrogen plasma on a cathode with microtips are well known in the art. The hydrogen plasma is then used to clean the microtips, to improve the subsequent emission capacity. Other known methods provide cleaning the microtips by means of a neutral gas plasma (for example, argon). On the anode side, its is also known to submit, at the end of the manufacturing, the anode plates to a plasma cleaning.

In all cases, the anode and/or cathode plates are placed in an enclosure of a plasma cleaning device.

FIG. 3 very schematically shows the structure of such a conventional cleaning device.

The screen plate to be processed (for example, anode plate 6) is introduced into an enclosure 20 of the device, to bear on a first wall 21 thereof. Opposite to wall 21 in enclosure 20 is located a counter-electrode 22 specific to the cleaning device. This counter-electrode is distant (generally by several centimeters) from anode 5, the various electric connections of which are connected to be biased, with respect to electrode 22, by a D.C. voltage source 23. Enclosure 20 is associated by a vacuum pump 24 communicating with the enclosure via a tubing 25. Further, a cleaning gas supply 26, provided with a control valve 28, is connected to a tank 27 of this gas. Moreover, the device is provided with a control system (not shown) adapted to synchronizing the operation of the cleaning device to force the generation of a plasma in a perfectly conventionally manner.

A disadvantage of the present technique of plasma cleaning of the cathode and/or the anode of a flat screen has to do with the fact that, once the cleaning is over, the processed plate is contaminated again after it comes out of enclosure 20, until it is assembled with the other screen plate. Indeed, unless transfers under vacuum or under a neutral atmosphere between the different screen processing stations are provided, which is difficult in practice, the consecutive layers of the cathode-grid or of the anode supported by the corresponding plate are exposed back to air until assembly, which causes a new contamination.

### SUMMARY OF THE INVENTION

The present invention aims at overcoming the disadvantages of known manufacturing methods using a step of plasma cleaning of at least one of the electrodes of a flat display screen.

The present invention more specifically aims at providing a novel manufacturing method, implementing at least one step of plasma cleaning of one of the screen electrodes, which suppresses any risk of subsequent contamination of this electrode.

The present invention further aims at providing a solution which is compatible with a method of non-vacuum assembly of the flat display screen, that is, a method in which the screen is exposed back to air between the plate assembly and the closing of its pumping tube.

The present invention further aims at providing a solution which requires no additional equipment as compared to the equipment usually required by screen manufacturing.

To achieve these objects, the present invention provides a method for cleaning by plasma at least one electrode of a field effect flat display screen, which consists of causing the generation of a plasma in an internal space separating two parallel plates respectively forming the screen bottom and surface, and each supporting at least one electrode, before placing this internal space under vacuum and definitively closing it.

According to an embodiment of the present invention, an electron emission by a cathode plate of the screen is caused during the plasma cleaning.

According to an embodiment of the present invention, the electron emission is organized in a line scanning.

According to an embodiment of the present invention, applied to a flat screen having an anode provided with several individually biasable conductors, the anode conductors are non-simultaneously biased.

According to an embodiment of the present invention, the bias voltages of the screen electrodes are chosen according to the thickness of the internal inter-electrode space.

The present invention also provides a method for assembling a flat display screen with the creation of an internal space between two parallel plates respectively forming the screen bottom and surface and each supporting at least one electrode, which consists, before closing and placing under vacuum of the internal space by obturating at least one pumping tube, of performing at least one plasma cleaning step.

According to an embodiment of the present invention, several successive steps of creation of a plasma in the internal space and of pumping via pumping tubes to evacuate contaminating species are performed.

The foregoing objects, features and advantages of the present invention will be discussed in detail in the following non-limiting description of specific embodiments in connection with the accompanying drawings.

### BRIEF DESCRIPTION OF THE DRAWINGS

FIGS. 1 to 3, previously described, are intended for showing the state of the art and the problem to solve; and

FIG. 4 shows a flat display screen in a plasma cleaning step according to the present invention.

### DETAILED DESCRIPTION

The same elements have been designated with the same references in the different drawings. For clarity, the representations of the drawings are not to scale and only those elements that are necessary to the understanding of the present invention have been shown in the drawings and will be described hereafter. In particular, the respective structures of the tools necessary for the gas supplies and the vacuum pumping as well as those of the electronic control circuits enabling implementation of the plasma cleaning methods will not be detailed since they are either perfectly well known, or readily implementable by using known means based on the functional indications provided in the present description.

A feature of the present invention is to use the screen itself as a plasma chamber. Thus, according to the present invention, internal volume 13 of the screen and its electrodes are used as a plasma cleaning device for at least one of its electrodes.

Advantage is thus taken of the fact that, once assembled, a flat display screen with microtips includes all the elements necessary to generate a plasma. It should however be noted that, unlike so-called plasma screens, this plasma only aims at cleaning the screen electrodes and not at taking part in the display. Advantage is also taken of the existence of a pumping tube or the like to enable placing the internal space under vacuum after cleaning, as well as to introduce a cleaning gas.

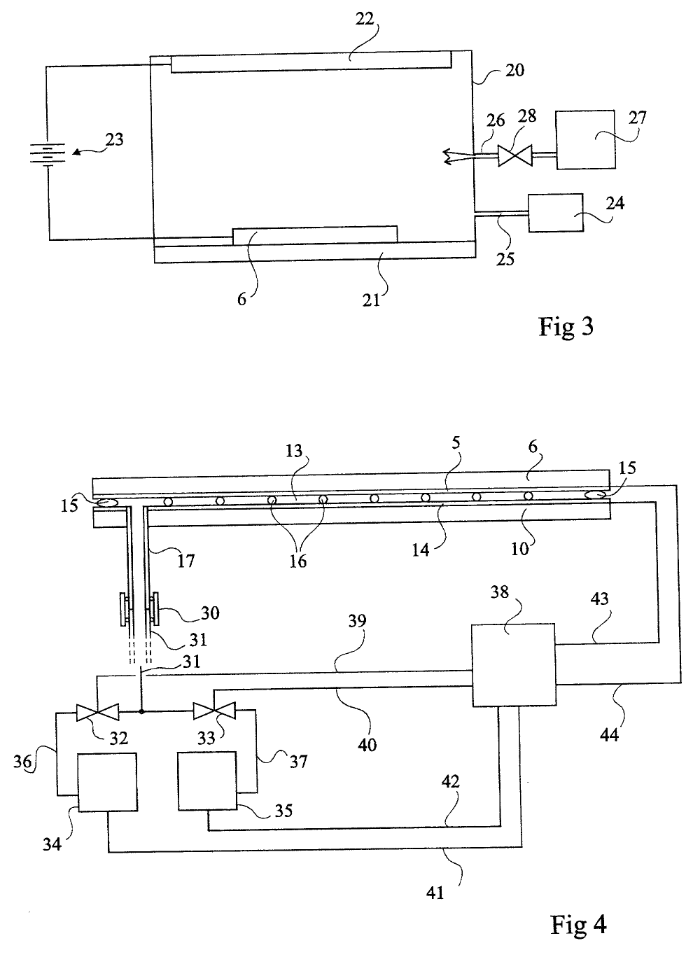

FIG. 4 very schematically illustrates an embodiment of the plasma cleaning method according to the present invention. This drawing shows, in a cross-section view, the different elements forming the screen schematically shown in FIG. 2, with the difference that the screen here is shown with pumping tube 17 open. Accordingly, to implement the cleaning method of the present invention, pumping tube 17 must not have been obturated yet. However, the rest of the screen assembly is performed, that is, plates 6 and 10 are assembled by means of peripheral seal 15, internal space 13 being defined by spacers 16.

Accordingly, according to the present invention, the cathode-grid and anode plates are submitted to all the conventional manufacturing steps except for the possible plasma cleaning steps. Further, the screen assembly is still performed conventionally as concerns the placing of the spacers, the possible degassings and the peripheral screen sealing. Once in this state, the screen is then submitted to the plasma cleaning process of the present invention. For this purpose, and as illustrated in FIG. 4, pumping tube 17 is connected, via a tight junction 30 (for example, a stuffing box) to a duct 31 of a cleaning installation according to the present invention. Duct 31 is, at its other end, connected to two valves 32 and 33 respectively communicating with a cleaning gas tank 34 for the plasma and with a vacuum pump 35 by ducts 36 and 37. Valves 32 and 33, tank 34, and vacuum pump 35 are controlled, for example, by a central system 38 exchanging information with these components via connections, respectively 39, 40, 41, and 42. According to the present invention, central system 38 is also electrically connected (by lines 43 and 44, possibly multi-wire) to connectors (not shown) of electric connection of the cathode, of the grid and of the anode of the flat display screen to be processed.

According to the present invention, the screen electrode biasing is used to generate the plasma. In the cleaning step, valve 33 is closed while valve 32 supplying the cleaning gas is open and the adequate biasing of the cathode-grid with respect to the anode enables generation of the cleaning plasma. Once the cleaning is over, the gases contained in internal space 13 are then pumped and vacuum is created therein by means of pump 35 before conventionally closing tube 17. For example, this closing of the tube can be performed at high temperature by locally melting the tube and applying a mechanical pressure thereon, or at low temperature if it is associated with an element made of a ductile metal, as described in above-mentioned French patent application no 2,761,196.

It should be noted that any other plasma cleaning method may be implemented. For example, the cleaning may be performed in “dynamic” mode, that is, under a flow of gas to be ionized. In this case, tube 17 (or another tube opening into the internal space) is used to introduce and simultaneously pump the plasma gas.

According to a preferred embodiment of the present invention, the electrode biasing is performed in different manners according to the desired type of cleaning (anode or cathode) and to the plasma used.

According to a first example of implementation, the cathode and grid electrodes are simultaneously short-circuited and biased by connection 43 while anode electrode(s) 5 are biased together by connection 44. The potential difference applied between the cathode and the anode is on the order of a few hundreds of volts, which is perfectly compatible with the voltages for which the operating screen and, in particular, inter-electrode space 13, are provided.

The choice of the bias voltages and of the gas pressures in the inter-electrode space depends on the thickness of this space and the plasma cleaning method is adapted accordingly.

Indeed, a specific problem which is posed upon use of the screen itself as a plasma chamber is the small thickness of inter-electrode space 13. In a conventional cleaning machine such as schematically illustrated in FIG. 3, the distance separating the two electrodes is generally of several centimeters for an operation under pressures on the order of 10⁻² to 10⁻¹ pascals. In a flat screen, the small inter-electrode space (smaller than 1 centimeter and, most often, smaller than 5 millimeters) requires much higher pressures. For example, for an inter-electrode space of less than 1 millimeter, pressures on the order of from 10² to 10⁴ pascals will be provided.

According to a preferred embodiment of the present invention, more specifically intended for the case where the inter-electrode space is small (less than 1 millimeter), the emission of electrons by the cathode microtips is used to favor the plasma ionization and thus reduce the necessary gas pressure. In this case, advantage is taken from the fact that all the electric connections of the cathode, of the grid, and of the anode are individually accessible on the finished screen and the different electrodes are adequately biased by means of system 38. It should be noted that, if necessary, a scanning of the electronic emission may even be performed. An advantage then is that the plasma is made more stable and that the risk of seeing localized arcs occur in the plasma, which would risk damaging the screen, is minimized.

Different specific embodiments of the present invention will be described hereafter. These embodiments essentially differ by the biasings applied to the screen electrodes to implement the plasma cleaning method according, in particular, to the available inter-electrode distance and to the electrode (anode or cathode) which is desired to be cleaned.

According to a first embodiment, more specifically intended for the case where the anode-cathode distance is sufficiently large (for example, on the order of one centimeter), it is considered that a plasma can be kept going with no electron emission. A voltage chosen to be smaller than the minimum emission voltage (generally on the order of 50 volts) is then applied between the cathode and the grid. For example, a null voltage will be chosen by interconnecting the grid and cathode electrodes.

For a cleaning of the cathode, a voltage having an absolute value greater than or equal to the plasma initiation voltage and such that the anode potential is greater than the cathode potential is applied between the anode and the cathode. Then, a voltage greater than or equal to the plasma excitation voltage is maintained between the anode and the cathode. During this step, the gas brought in by supply 31 and pumping tube 17 turns into plasma. The positive ionized species will bombard the cathode to clean it. The plasma is maintained for a duration necessary to clean the cathode.

For a cleaning of the anode, a voltage having an absolute value greater than or equal to the plasma initiation voltage and such that the cathode potential is greater than the anode potential is applied between the anode and the cathode (the cathode-grid voltage being always such that the microtips do not emit). Then, a voltage with an absolute value greater than or equal to the plasma excitation voltage is maintained between the cathode and the anode to ensure the turning of the cleaning gas into plasma. The positive ionized species will then bombard the anode to clean it and, as previously, the plasma is maintained for the duration necessary to the cleaning.

According to a second embodiment more specifically intended for the case where the inter-electrode space is small (for example, smaller than one millimeter), the screen electron emission capacities are used to favor the creation of the plasma. However, a problem that then arises is that, in such a small inter-electrode space, it will be difficult to have a stable plasma. Accordingly, according to the present invention, the electron emission is performed in a scanning (for example, the conventional line scanning of the display). A displacement of the plasma in the entire screen is thus obtained, which enables avoiding instability phenomena.

For a cleaning of the cathode, a microtip emission is caused, for example, by applying a cathode-grid voltage (ranging between 50 and 80 volts). The grid lines are scanned with a scanning frequency chosen according to the stability features of the plasma. For each line, a positive voltage greater than or equal to the plasma initiation voltage between the anode and the cathode is applied. Then, a positive voltage greater than or equal to the plasma excitation voltage is applied between the anode and the cathode to turn the cleaning gas into plasma. The electrons then emitted by the addressed microtips are attracted by the anode. The positive ionized species will bombard the cathode to clean it. As previously, the plasma scanning duration depends on the time necessary to clean the cathode.

For a cleaning of the anode, an emission of the microtips is still provided, but by applying a negative voltage having an absolute value greater than or equal to the plasma initiation voltage, then greater than or equal to the plasma excitation voltage between the cathode and the anode. During this step, the electrons emitted by the addressed tips fall back on the cathode and the positive ionized species will then bombard the anode to clean it.

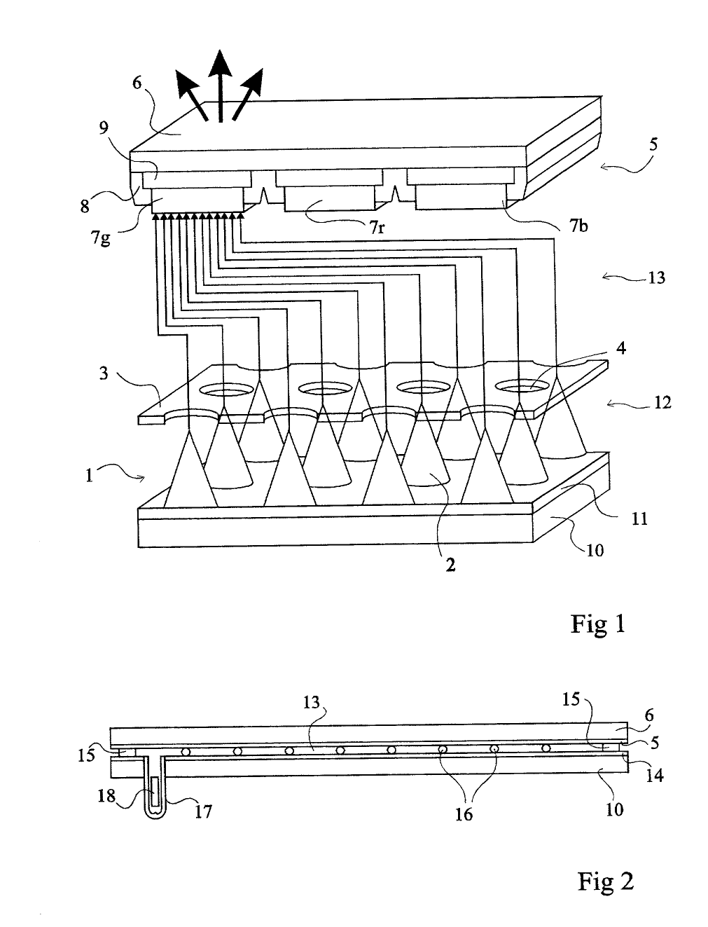

It should be noted that, in the case of a so-called switched anode, that is, an anode provided with several individually biasable anode conductive patterns (for example, a trichromatic anode such as illustrated in FIG. 1), advantage may also be taken from an addressing, for example sequential, of the anode to improve the stability of the plasma. Such an addressing may of course be combined with the line scanning, on the cathode side.

An advantage of the present invention is that no new exposure to air is necessary between the plasma cleaning of the anode and/or of the cathode and the vacuum closing of the internal screen space. Thus, any contamination of the screen electrodes is avoided.

Another advantage of the present invention is that it is possible to pass from an anode cleaning phase to a cathode cleaning phase by mere inversion of the biasing of the anode-cathode voltage.

Preferably, if the cleaning is performed in a “static” mode, the cleaning phases are repeated several times, that is, an introduction of gas, a plasma cleaning, and a pumping by vacuum pump 35 to evacuate contaminating species are performed successively several times. It will however be ascertained that the gas pressure during plasma cleaning phases is maintained substantially constant.

In dynamic mode (scanning of the gas to be ionized), the pressure will also be, preferably, maintained substantially constant.

Of course, the present invention is likely to have various alterations, modifications, and improvements which will readily occur to those skilled in the art. In particular, the choice of the cleaning gas (for example, argon, hydrogen, or other) is within the abilities of those skilled in the art just as for a conventional plasma cleaning in a separated installation. Similarly, adapting the electrode biasing potentials in the implementation of the method of the present invention is within the abilities of those skilled in the art based on the functional indications given hereabove. In particular, it will be ascertained to maintain a potential difference between the grid and the cathode, which enables either blocking the electron emission or, conversely, causing an electron emission (if necessary in a line scanning).

Further, it should be noted that the implementation of the present invention is compatible with all known pumping tube closing systems, as well as with all the shapes given to these tubes. For example, although the present invention has been described hereabove in relation with a pumping tube perpendicular to the screen plane, it should be noted that this pumping tube may be as an alternative parallel to the screen plane. Similarly, the present invention also applies to the case where the internal space communicates with several pumping tubes.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for cleaning by plasma at least one electrode (5, 14) of a field effect flat display screen, consisting of causing the generation of a plasma in an internal space (13) separating two parallel plates (6, 10) respectively forming the screen bottom and surface, and each supporting at least one electrode, before placing this internal space under vacuum and definitively closing it.

2. The method of claim 1, consisting of causing an electron emission by a cathode plate (10) of the screen.

3. The method of claim 2, the cathode plate is line scanned.

4. The method of claim 3, applied to a flat screen having an anode provided with several individually biasable conductors, consisting of non-simultaneously biasing the anode conductors.

5. The method of claim 4, wherein the bias voltages of the screen electrodes are chosen according to the thickness of the internal inter-electrode space (13).

6. A method for cleaning by plasma at least one electrode (5, 14) of a field effect flat display screen, consisting of causing the generation of a plasma in an internal space (13) separating two parallel plates (6, 10) respectively forming the screen bottom and surface, and each supporting at least one electrode, before placing this internal space under vacuum and definitively closing it, wherein lines of a cathode plate (10) of the screen are scanned during the plasma cleaning.

7. A method for assembling a flat display screen with the creation of an internal space (13) between two parallel plates respectively forming the screen bottom and surface and each supporting at least one electrode (5, 14), consisting, before closing and placing under vacuum of the internal space by obturating at least one pumping tube (17), of performing at least once the plasma cleaning step of any of claims 1 to 6.

8. The assembly method of claim 7, wherein several successive steps of creation of a plasma in the internal space (13) and of pumping via pumping tubes (17) to evacuate contaminating species are performed.
